(19) United States
(12) Patent Application Publication
(10) Pub. No.: US 2010/0317824 A1
(43) Pub. Date: Dec. 16, 2010

(54) POLYETHER DERIVATIVES OF SECONDARY HYDROXY FATTY ACIDS AND DERIVATIVES THEREOF

(75) Inventors: Johan A. Thoen, Antwerpen (BE); Jean-Paul Masy, Destelbergen (BE)

Correspondence Address: The Dow Chemical Company, P.O. BOX 1967, Midland, MI, 48641, US

(73) Assignee: Dow Global Technologies Inc., Midland, MI (US)

(21) Appl. No.: 12/634,246

(22) Filed: Dec. 9, 2009

Related U.S. Application Data
(63) Continuation-in-part of application No. PCT/US2009/047356, filed on Jun. 15, 2009.

(51) Int. Cl. C08G 63/66

(52) U.S. Cl. 528/361

(57) ABSTRACT

A compound that is a polyether of a saturated monobasic secondary hydroxyl fatty acid, preferably 12-hydroxy stearate, or a reaction product of the polyether with a polyhydric alcohol, a capping agent or a combination of both. Prepare the compound by contacting a saturated hydroxy monobasic fatty acid or derivative thereof with an alkoxide in the presence of a double metal cyanide catalyst such that a polyether of the fatty acid is formed. Optionally, preparation also includes a step of capping the polyether, or alternatively, contacting the polyether with a polyhydric alcohol.

### CROSS-REFERENCE TO RELATED APPLICATIONS

This application is a non-provisional application claiming priority from the U.S. Provisional Patent Application No. 61/075,498, filed on Jun. 25, 2008, entitled “POLYETHER DERIVATIVES OF SECONDARY HYDROXY FATTY ACIDS AND DERIVATIVES THEREOF,” and a continuation in part application of Patent Cooperation Treaty Application (PCT/US2009/047356, filed Jun. 15, 2009, entitled “POLYETHER DERIVATIVES OF SECONDARY HYDROXY FATTY ACIDS AND DERIVATIVES THEREOF”, the teachings of which are incorporated by reference herein, as if reproduced in full hereinbelow.

This invention relates to derivatives of hydrogenated castor oil and their use in polyurethanes, lubricants and other functional fluids. More specifically, the invention relates to polyethers of hydrogenated castor oil and derivatives thereof.

Castor oil-based lubricants have an advantage of being based on renewable resources, but a disadvantage of having limited thermal oxidative stability because of triglyceride bonds and unsaturated compounds. Furthermore natural oils like castor oil have a high level of linear saturated materials that appear to adversely affect pour point performance (e.g. increase it from −5 degrees centigrade (° C.) to +5° C.) when present in a lubricant or other functional fluid.

Isolated hydroxy-substituted fatty acids or combinations thereof may be obtained from natural oils either directly such as ricinoleic acid (12-hydroxyocta-decenoic acid (12-HODA)) from castor oil, or by derivation such as production of 12-hydroxy stearic acid (12-HSA) from hydroxyoctadecanoic acid. Esters of such acids, particularly esters of 12-HODA, have known utility in lubricants, but these esters are usually linear polyesters or even salts of the acids. Such esters are generally linear rather than short chain branched, that is having branches of less than (<) 12 carbon atoms (C₁₂). For instance, each hydroxy fatty acid is reacted with the hydroxyl group of the previous fatty acid in a linear chain. Linear polyesters of this nature have limitations in viscosity, pour point and thermo-oxidative stability. Frequently there are free hydroxyl groups which tend to further react resulting in viscosity increase.

It would be desirable to have a branched derivative of a fatty acid, preferably of 12-HSA, effective as a lubricant or functional fluid and based primarily on renewable resources, but which overcomes disadvantages of linear polyesters and triglyceride castor oil based lubricants. The branched derivative preferably has at least one of (a) good friction properties as indicated by a “low” coefficient of friction determined using Stribeck curves as established on a PCS MTM Minitraction machine of <0.07, preferably at most (≦)0.06, more preferably 0.05; (b) a low pour point, that is a pour point of <0° C. measured in accord with American Society for Testing and Materials (ASTM) D97; (c) useful viscosity characteristics, that is a viscosity, measured in accord with ASTM D445-94, of ≦200 centistokes (cSt) (2×10⁻⁴ square meters per second (m²/s), preferably ≦100 cSt (1×10⁻⁴ m²/s), at 40° C., and (d) good thermal oxidative stability as indicated by an acidity increase, measured in accord with DIN 51 587, of ≦5 milligrams of potassium hydroxide per gram (mg KOH/g), preferably ≦2 mg KOH/g.

In some aspects, this invention includes a compound that is a polyether of a saturated monobasic secondary hydroxyl fatty acid, preferably 12-HSA. The polyether is optionally formed from a derivative of the fatty acid, for instance an ester of the fatty acid, most preferably methyl 12-hydroxy stearate (M-12-HS), to provide a monobasic secondary hydroxy fatty acid moiety. The monobasic secondary hydroxy fatty acid moiety optionally comes from any compound capable of introducing such a moiety, for instance a monobasic secondary hydroxy fatty acid, anhydride, chloride or ester thereof, and is, independently, most preferably a 12-HSA moiety.

In various aspects, this invention includes compositions comprising derivatives of polyethers of such saturated fatty acids, wherein hydroxyl groups are capped, and wherein a resulting polyether is reacted with a polyhydric alcohol to form a polyester of the polyether or a combination thereof.

When the saturated monobasic secondary hydroxy fatty acid is 12-HSA, the alkylene oxide has no more than one alkyl group and is represented by C₂H₃R¹O, where R1 is hydrogen (H) or an alkyl group (for instance H for ethylene oxide, or CH₃— for propylene oxide) and the polyhydric alcohol is a diol, the polyether may be structurally represented by Formula 1:

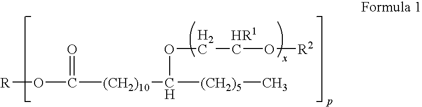

wherein x is an integer within a range of from 1 to 30; p is an integer within a range of from 2 to 8; R is any alkyl, alkenyl, alicyclic or heterocyclic moiety, preferably of ≧5 carbon atoms, more preferably ≧6 carbon atoms, and independently preferably ≦12 carbon atoms, more preferably ≦10 carbon atoms, and most preferably ≦8 carbon atoms; R¹ is hydrogen (H) or a methyl group (—CH₃) (for instance H for ethylene oxide or CH₃— for propylene oxide); and R² is H or a methyl group, —C(═O)R³ (wherein R³ is a hydrocarbyl group of from 1 carbon atom to 18 carbon atoms), —CR⁴R⁵—CR⁶R⁷—OH where R⁴, R⁵, R⁶ and R⁷ are each independently H or a hydrocarbyl group of at least 1 carbon atom to at most 10 carbon atoms, wherein the sum of the carbon atoms in R⁴, R⁵, R⁶ and R⁷ is at least 2 carbon atoms and at most 10 carbon atoms. The branched structure of the polyether fatty polyester product is evident even from this simplistic structural representation.

In various aspects, this invention includes a process comprising a step of (1) contacting a saturated secondary hydroxy monobasic fatty acid or derivative thereof with an alkylene oxide in the presence of a double metal cyanide (DMC) catalyst to form a polyether of the fatty acid or derivative. Optionally, the process also includes a step (2) capping the resulting polyether, or alternatively, contacting a resulting polyether with a polyhydric alcohol, or both.

In various aspects, this invention includes a compound or composition that is or comprises a reaction product of a saturated secondary hydroxyl monobasic fatty acid or derivative thereof and an alkylene oxide formed in the presence of a DMC catalyst. Capped and polyester derivatives of such reaction products are also included in this invention.

This invention further includes compositions (e.g. functional fluids) comprising at least one of the above compounds, which fluids are preferably plasticizers, lubricants, power transmission fluids, solvents or surfactants. The invention also includes polyols which are or comprise such compounds or compounds derived from such compounds and polyurethanes that are reaction products of such polyols as well as articles made from such polyurethanes.

“Friction properties” designates an ability to ameliorate effects of friction between surfaces at least one of which is moving with respect to the other and can be measured using an instrument designed for such measurements, for instance, a PCS Instruments (MTM2 Minitraction Machine) commercially available from PCS Instruments Ltd, London, UK. Measurement conditions preferably include slide-roll-ratio (SRR) 50 percent (%), load 50 Newtons (N), speed 100 millimeters per second (mm/sec), and temperature 40° C. in which a steel ball (¾ inch (1.9 centimeters (cm))) is rotated on a steel disc)

“Wear properties” indicates an ability to reduce wearing of two objects in contact with each other, at least one of which is moving with respect to the other, and is also measured by an instrument such as that used to measure friction properties.

“Pour point” refers to a temperature at which a material solidifies as measured in accord with ASTM D97.

“Thermal oxidative stability” means resistance to deterioration in the presence of heat (at least (≧)95° C.) and oxygen measured in accord with Deutsches Institut für Normung e.V. (DIN) 51587.

“Polyether” designates a compound having ≧two ether oxygen atoms separated by a hydrocarbyl group. Preferably, it is the reaction product of ≧two moles of an alkylene oxide with a hydroxyl group of another compound.

“Alkylene oxide” refers to an organic compound having an epoxide group.

“Polyhydric alcohol” designates an organic compound having ≧two hydroxyl groups.

“Fatty acid” means a long-chain carboxylic acid, with chain length of ≧4 carbon atoms. Typical fatty acids have chain lengths of 4 to 18 carbon atoms (C₄-C₁₈), though some have longer chains. Linear, branched, or cyclic aliphatic groups may be attached to the long chain. Fatty acid residues may be saturated or unsaturated, and optionally have functional groups in addition to the acid group.

A “saturated” fatty acid has no double, triple or aromatic carbon to carbon bonds. Those skilled in the art recognize, however, that a certain saturated acid might, usually because of its origin in nature, actually occur in mixtures which may contain some unsaturated molecules. Saturated fatty acids used herein as starting materials preferably have only incidental or inadvertent amounts of unsaturated compounds in admixture with the saturated fatty acid, more preferably ≦3 iodine number (mg KOH/g), most preferably ≦2 iodine number (mg KOH/g) of unsaturation. Measure such unsaturation in mixtures by any known means, preferably by ASTM D5768-2 (2006).

“Hydroxy fatty acid” designates a fatty acid having ≧one hydroxyl group, preferably a secondary hydroxyl group. The hydroxyl group is optionally present in the acid as obtained from a natural oil or is introduced by chemical reaction such as by reaction at a double bond, for instance, by epoxidation, reaction with a compound such as maleic anhydride, by oxidation, by reaction with water such as blown oils where moist air is used in the presence of a catalyst such as cobalt, by epoxidation with propylene oxide or higher alkylene oxide, by reaction with aqueous perchloric acid or hydrogen peroxide and the like. “Monobasic hydroxy fatty acid” designates a fatty acid that has one carboxyl group.

“Capping agent” or “capping reagent” refers to any compound capable of reacting with a hydroxyl group such that the hydroxyl group's active hydrogen atom is replaced by a group not having a reactive hydrogen atom, that is, not having an active hydrogen or having a functional group which is not sufficiently reactive to have appreciable detrimental effects in intended end uses. Exemplary and preferred capping reagents include carboxylic esters, anhydrides, chlorides or acids that lack alcohol or amine functionality. Suitable capping agents include short chain carboxylic acids, their anhydrides, their chlorides and their alkyl esters of wherein the carboxylic acid or derivative thereof has two to eighteen carbon atoms (C₂-C₁₈), advantageously six to twelve carbon atoms (C₆-C₁₂), preferably six to ten carbon atoms (C₆-C₁₀), more preferably short chain carboxylic acids or short chain lower alkyl esters of C₈ and C₁₀ carboxylic acids, mixtures of two or more of such carboxylic acids or lower alkyl esters (e.g. a mixture of short chain lower carboxylic acids or short chain lower alkyl esters of C₈ and C₁₀ carboxylic acids), and even more preferably one or more carboxylic acids or methyl esters of such carboxylic acids. Alternatively, capping agents are epoxides having ≧4 carbon atoms, preferably ≦8 carbon atoms. Such epoxides are preferably linear or branched alkyl-oxiranes like n-alkyloxiranes, 2-ethylalkyloxiranes and 2,3-butyloxiranes and combinations thereof. Epichlorohydrin, methyl chloride, dimethyl sulfate, sodium methoxide and other compounds known in the art to react with hydroxyl groups to produce ethers are among other alternative capping agents.

“Moiety” and “structural element” refer to a portion of a molecule comprising ≧two atoms bonded to each other within a structural element and ≧one atom bonded to ≧one other atom in the molecule. The moiety or structural element preferably retains structural characteristics, at least structural skeleton of its chemical source.

“Renewable resource” refers to annually renewable resources such as compounds of animal and plant origin as distinguished from, for instance, petroleum or mineral oils and derivatives thereof.

All percentages, preferred amounts or measurements, ranges and endpoints thereof herein are inclusive. Unless stated otherwise, numbers herein have no more precision than stated. Furthermore, all lists are inclusive of combinations of two or more members of the list. Thus, a range that has an advantageous lower limit combined with a most preferred upper limit is a preferred range for the practice of this invention. All amounts, ratios, proportions and other measurements are by weight unless stated otherwise, implicit from the context, or customary in the art. All percentages refer to weight percent (wt %) based on total composition weight. Unless stated otherwise or recognized by those skilled in the art as otherwise impossible, steps of processes described herein are optionally carried out in sequences different from the sequence in which the steps are discussed herein. Furthermore, steps optionally occur separately, simultaneously or with overlap in timing

Unless stated otherwise, “or” refers to the listed members individually as well as in any combination of some or all of the listed members.

The compound of some aspects of this invention is a reaction product of an alkylene oxide and a saturated monobasic secondary hydroxy fatty acid or mixture of such acids. Reactant stoichiometry is such that every hydroxyl group on the saturated monobasic hydroxyl fatty acid molecule reacts with ≧two molecules of alkylene oxide (sequentially) to form a polyether.

The compound has, at its core, a molecular moiety from a saturated secondary hydroxyl monobasic fatty acid.

Saturated monobasic secondary hydroxy fatty acids, especially 12-HSA, are commercially available. Other fatty acids that have a secondary hydroxyl group, e.g. those derived from Lesquerella seeds, are also useful. See Kleiman, R. “Chemistry of New Industrial Oilseed Crops” p. 196-203, in: J. Janick and J. E. Simon (eds.), Advances in New Crops, Timber Press, Portland, Oreg. (1990).

12 HSA (hereinafter exemplary of saturated monobasic secondary hydroxyl fatty acids) is preferably used as a derivative thereof, preferably as an anhydride, a halide or, more preferably, an ester, most preferably the methyl ester, methyl 12-hydroxy stearate (M12HS).

M12HS) is preferably reacted with (that is alkoxylated by) an alkylene oxide (e.g. ethylene oxide (EO), propylene oxide (PO), or a combination thereof) to form a corresponding polyether at the molecular site of the hydroxyl group. Any alkylene oxide having an epoxide group sufficiently reactive to react with the hydroxide group on M12HS such that the epoxide ring is opened, forming an ether group at the fatty acid hydroxyl group and another hydroxyl group for further reaction with additional alkylene oxide from the epoxide oxygen is suitable for use in practicing various aspects of this invention. When more than one alkylene oxide is used, they are optionally used in admixture to form a random polyether structure or in sequence to form a block polyether structure. In one aspect, particularly for use as a polyol in making polyurethanes, pure ethylene oxide or mixtures of propylene oxide and ethylene oxide having a high proportion of ethylene oxide are preferably added as a terminal block or used for the entire polyether chain, such that the polyether chains bonded to the M12HS have ≧50 mole percent (mol %), more preferably ≧70 mol %, most preferably ≧90 mol % of primary OH terminal groups. In an alternative aspect, particularly for use in lubricants and other functional fluids, at least terminal block of polyether residues derive from propylene oxide to give a secondary hydroxyl group. More preferably the polyether molecular structure is formed from propylene oxide alone. When a mixture of ethylene oxide and propylene oxide is used, preferably propylene oxide is at least 50 wt %, more preferably at least 60 wt % and most preferably at least 70 wt % of the combination of alkylene oxides.

The molar ratio of M12HS to alkylene oxide is preferably ≦1:30, more preferably ≦1:20 and most preferably ≦1:10; independently the ratio is preferably ≧1:1, more preferably ≧1:5 and most preferably ≧1:7.

While alkoxylation of M12HS is catalyzed both by Lewis acids such as BF₃O(Et)₂ or B(C₆F₅)₃ and by bases such as alkali or alkaline-earth metal hydroxides, DMC catalysts are preferred because ester bonds of the M12HS are subject to fewer secondary reactions when a DMC catalysis used.

DMC catalysis is well within the skill in the art as illustrated by such patent references as U.S. Pat. Nos. 3,404,109, 3,829,505, 3,941,849 and 5,158,922, 5,470,813, EP-A 700 949, EP-A 743 093, EP-A 761 708, WO-A 97/40086, WO-A 98/16310 and WO-A 00/47649 which are incorporated by reference herein to the extent permitted by law.

Alkoxylation of the M12HS is carried out under reaction conditions effective to form a polyether molecular structure at the site of the secondary hydroxyl group on the M12HS. Such processes are within the skill in the art as exemplified by WO-A 97/29146 and WO-A 98/03571. The reaction is suitably batch or continuous or a combination thereof. Such conditions preferably include contact of the M12HS and an alkylene oxide in the presence of a DMC catalyst in a reactor under a pressure that is preferably ≧0.1 Bar (10 kilopascals (kPa)), more preferably ≧0.5 Bar (50 kPa), most preferably ≧1.0 Bar (100 kPa), and independently preferably ≦15 Bar (1500 kPa), more preferably ≦10 Bar (1,000 kPa), most preferably ≦5 Bar (500 kPa). If catalyst exits the reactor with the product in a continuous reaction, then it is advantageously replaced, preferably recovered and recycled to the reactor. Consumption of alkylene oxide is advantageously quantified by monitoring the pressure. When constant pressure is reached, the product can be removed, optionally after one or more additional reactions, a waiting period or a combination thereof. Convenient reaction temperatures are usually ≧20° C., preferably ≧90° C., more preferably ≧100° C., most preferably ≧120° C., and independently preferably ≦200° C., more preferably ≦180° C., most preferably ≦160° C. Reaction time depends on such parameters as concentration of reactants, pressure and temperature. In a batch reaction, reaction times are preferably ≧two hours, more preferably three hours, most ≧five hours, and independently preferably ≦10 hours, more preferably ≦eight hours. A solvent is optionally used, such as toluene, tetrahydrofuran (THF) or a combination thereof. When a solvent is used, convenient amounts are often preferably ≧10 wt %, more preferably ≧8 wt %, most preferably ≧5 wt %, and independently preferably ≦30 wt %, more preferably ≦20 wt %, most preferably ≦15 wt %, each wt % being based on expected weight of end product. Catalyst concentration is selected to achieve control of the formation of the polyether. Effective amounts vary with the reactants and the catalyst as well as reaction conditions, but for the DMC catalysts disclosed in the cited art, catalyst concentration is often preferably ≧20 parts by weight per million parts by weight (ppm), more preferably ≧100 ppm, and independently preferably ≦500 ppm, more preferably ≦300 ppm, most preferably ≦150 ppm (parts per million by weight) based on total amount of end product expected to be produced.

The reaction product of M12HS and alkylene oxide is a fatty acid, anhydride or ester as previously described having a polyether group or moiety on the carbon of the original hydroxyl group, in the case of M12HS, on the 12 carbon. The polyether moiety is terminated by a hydroxyl group which is primary if the last alkylene oxide added is ethylene oxide or secondary if the alkylene oxide has more than two carbon atoms. This reaction product is referred to herein as a polyether fatty acid or alkoxylated fatty acid, although those skilled in the art will recognize that the acid is optionally in the form of the anhydride or ester, that is, the same form as the starting material. In the case of M12HS, the product is referred to herein as 12-polyether methyl stearate or alkoxylated M12HS. The polyether fatty acids are compounds of some aspects of this invention.

The polyether fatty acid is optionally, but preferably, further reacted with a polyhydric alcohol or polyhydric alcohol mixture. Examples of preferred polyhydric alcohols include trimethylolpropane (TMP), pentaerythritol (PE), dipentaerythritol (DPE), neopentyl glycol (NPG), 2-methyl-2-propyl-1,3-propanediol (MPPD) and combinations thereof. The polyhydric alcohol has an average of two ≧hydroxyl groups, preferably ≧three hydroxyl groups, more preferably four ≧hydroxyl groups, and independently preferably ≦eight hydroxyl groups, more preferably ≦six hydroxyl groups, and most preferably ≦five hydroxyl groups. The polyhydric alcohol preferably has an average equivalent weight of 24 Daltons, preferably ≧30 Daltons, more preferably ≧52 Daltons, and independently preferably ≦100 Daltons, more preferably ≦90 Daltons, and most preferably ≦80 Daltons.

The hydroxyl groups on the polyhydric alcohol are esterified with the carboxyl group of the polyether fatty acid. When the polyether fatty acid is in the form of the acid or anhydride, the reaction is a simple esterification. If the polyether fatty acid is in the form of an ester such as the methyl ester, M12HS, the reaction is a transesterification. See Oleochemical Manufacture and Applications, Frank D. Gunstone and Richard J. Hamilton, ISBN¹-84127-219-1, Sheffield Academic Press Ltd, Sheffield S11 9 AS United Kingdom for a discussion of esterification and transesterification reactions.

In esterification, contact the polyether fatty acid or its anhydride and the polyhydric alcohol, preferably in the presence of an acidic or basic catalyst, under reaction conditions sufficient to result in formation of an ester between the acid and hydroxyl groups. Temperatures conveniently are ≧150° C., preferably ≧170° C., more preferably ≧190° C. independently to preferably ≦240° C., more preferably ≦220° C., most preferably ≦200° C. at atmospheric pressure. The pressure is conveniently atmospheric pressure, but lower pressures are also useful, for instance, the pressure is preferably ≧20 (hPa), preferably ≧30 hPa, more preferably ≧50 hPa independently to preferably ≦200 hPa, more preferably ≦150 hPa, most preferably ≦100 hPa. For pressure measurements, 1 bar=100,000 pascals (Pa)=100 kilopascals (kPa)=1000 hectopascals (hpa). The amount of catalyst is preferably ≧100 ppm, preferably ≧200 ppm, more preferably ≧400 ppm independently to preferably ≦3000 ppm, more preferably ≦2000 ppm, most preferably ≦1000 ppm, based on total weight of reactants. Reaction time depends on such variables as temperature, pressure, type of catalyst and catalyst concentration. In most instances, the time is ≧240 minutes. Preferably, the reaction time is ≧500 minutes, more preferably ≧450 minutes, more preferably seven hours to preferably ≦90 hours, more preferably ≦40 hours and most preferably ≦20 hours. Hydrocarbons are optionally used as entrainment agents to facilitate removal of volatile components from a (trans)esterification reaction. Useful hydrocarbons include aliphatic and aromatic hydrocarbons such as iso-octane, toluene, xylene and combinations thereof.

In a transesterification reaction, one preferably contacts reactants in the presence of a transesterification catalyst and under reaction conditions. Catalysts include tin, titanium, zinc, or cobalt catalysts, carbonate catalysts (for instance, potassium carbonate (K₂CO₃), sodium carbonate (NaHCO₃), or, preferably, lithium carbonate (LiCO₃)), or other bases (e.g. sodium hydroxide (NaOH) or potassium hydroxide (KOH)) or a combination thereof. Organometallic catalysts, particularly those of tin and titanium are preferred. Exemplary tin catalysts include tin (II) octanoate, tin (II) 2-ethylheptanoate, dibutyl tin (IV) dilaurate, and other tin catalysts which are similarly functionalized. Exemplary titanium catalysts include tetra-n-butyl titanate, titanium tetraisopropoxide, titanium tetraisobutoxide, or any appropriately functionalized titanium (IV) alkoxide.

The catalyst is present in an amount effective to result in the reaction between the acid ester and hydroxyl group to form the resulting ester at a desirable rate. The amount depends, for example, on type of catalyst and reactants. When a tin, titanium or carbonate catalyst is employed, the amount of catalyst is advantageously ≧100 ppm, preferably ≧250 ppm, more preferably ≧500 ppm, and most preferably ≧1000 ppm based on total weight of reactants. Considerations other than operability determine any preference for upper limits. While more is operable, even suitable, such considerations as cost of the catalyst or necessity of deactivating or removing excess would indicate that, in most cases, an amount of catalyst would be preferably ≦2500 ppm, more preferably ≦2000 ppm, most preferably ≦1500 ppm, based on total weight of reactants.

For transesterification, reaction times, temperatures and pressures are preferably the same as those disclosed above for esterification. The reaction time is dependent on such variables as temperature, pressure, type of catalyst and catalyst concentration.

In both esterification and transesterification, near stoichiometric amounts of reactants are preferably used to achieve desired end products. Especially in the reaction of polyhydric alcohol and polyether fatty acid, avoid a large excess of polyether fatty acid to minimize formation of polyether fatty acid chains, that is, reaction of the hydroxyl group on the polyether chain with a carboxylic group of the fatty acid, anhydride or ester group. Preferably. the molar ratio of polyether fatty acid to hydroxyl groups on the polyhydric alcohol is <1.1/1.0, more preferably <1.05/1.0 and most preferably <1.01/1.0 and independently preferably ≧0.90/1.0, more preferably ≧0.95/1.0, most preferably ≧1.0/1.0 to avoid unreacted hydroxyl groups on the polyhydric alcohol.

Alternatively, produce the same polyether fatty polyester product by first reacting the saturated monobasic secondary hydroxy fatty acid or derivative with a polyhydric alcohol and then alkoxylating the product of that reaction with an alkylene oxide.

The product of the reaction between a polyether fatty acid and a polyhydric alcohol has as many ester groups as there are hydroxyl groups on the polyhydric alcohol, and is, therefore, referred to herein as a “polyether fatty polyester”.

The polyether fatty polyester has as many hydroxyl groups on polyether chains as there are hydroxyl groups on the polyhydric alcohol to each react with a M12HS. Thus, the polyether fatty polyester is a polyol. As such, it is useful in making polyurethanes or other polymers by reacting the polyether fatty polyester with such monomers as polyisocyanates, for instance toluene diisocyanate, methylene diphenyl diisocyanate, and polymers thereof. Preselect the number of hydroxyl groups on the polyether fatty polyester by choosing a polyhydric alcohol of desired functionality. Similarly, preselect percentage of primary and secondary hydroxyl groups by choice of alkylene oxide in making the polyether chain of the polyether fatty polyester. The polyurethanes find use in application such as flexible foams, rigid foams, coating, elastomers, and adhesives.

The above polyols are also useful in making copolymer thermoplastic resins, in thermoset epoxy applications or as surfactants, solvents, oils of lubricating viscosity, heat transfer fluids, and power transmission fluids.

For use in functional fluids such as lubricants, power transmission fluids, heat transfer fluids, thickening agents, surfactants, solvents, and plasticizers, optionally cap either the polyether fatty acid derivative or the polyether fatty polyester. Capping is a reaction of an active functional group on the polyether fatty acid derivative (preferably ester) or polyether fatty polyester, particularly a hydroxyl group with another molecule such that there is no longer a reactive functional group (preferably hydroxyl group). Free hydroxyl groups are preferably capped by reaction with monobasic alkyl carboxylic acid capping agents, that is the acid or an acid derivative reactive with the hydroxyl group, preferably the acid, anhydride or ester form.

The capping agent may be an epoxide that results in a hindered hydroxyl group.

The capping agent may also be epichlorohydrin which reacts with a hydroxyl group under conditions effective to produce a glycidyl ether, preferably at a temperature of ≧80° C. and ≦120° C., independently preferably a pressure of ≧50 kPa and ≦5000 kPa, independently preferably at concentrations of epichlorohydrin to free hydroxyl group of ≧1.0/1.05 and ≦1.0/1.10, and independently preferably for a time of ≧two hours and ≦five hours.

Alternatively, the hydroxyl groups of the polyether fatty polyester of the invention may be capped with methyl groups, e.g. as disclosed in such references as U.S. Pat. No. 4,587,365 or EP-β 0 302 487. It is advisable to carry out the reaction at a temperature of ≧60° C., preferably ≧80° C. and independently ≦120° C., preferably ≦100° C. In this case, the end capping reaction is a Williamson's ether synthesis which occurs in the presence of at least stoichiometric quantities of a strong base, for example an alkali metal hydroxide or alkoxide. In addition, it is advantageous to use the alkoxylated hydroxy-fatty acid ester, the base and the methylating agent in a molar ratio of approximately 1:1 (that is, preferably a ratio of from 1.05 to 2.0 moles of base to 1.05 to 2.0 moles of methylating agent).

If the polyether fatty polyester or polyether fatty acid derivative has a free carboxylic acid or anhydride group, it is also preferably reacted to form the ester. Preferably the ester is formed before alkoxylation.

While optionally prepared using similar reactions, the capped polyether fatty polyesters described herein differ from art recognized end-capped fatty alcohol polyglycol ethers, so-called “mixed ethers” (e.g. as described by R. Piorr in Fat Sci. Technol. 89, 106 (1987)) used as low-foaming surfactants. These products are generally butyl-end-capped nonionic surfactants. See e.g., EP-A 0 124 815, EP-B 0 303 928, EP-B 0 324 340, EP-A 0 420 802, DE-A 39 28 600 and DE-C 42 43 643. In contrast, the capped polyether fatty polyesters described herein have both ether and ester functionality and are branched as illustrated in Formula 1 above. In similar ways, the capped polyether fatty polyesters differ from methyl-end-capped methyl mixed ethers normally prepared by reaction of corresponding fatty alcohol polyglycol ethers with methyl halides as disclosed in U.S. Pat. No. 4,587,365, or dimethyl sulfate as in EP-B 0 302 487.

The molar ratio of monobasic alkyl carboxylic acid capping agent to polyether fatty polyester is preferably ≧1/1, more preferably ≧1.01/1 to minimize presence of free hydroxyl groups in the final product, and independently preferably ≦2.0/1, most preferably ≦1.05/1. Molar ratios like 2.0/1 are used to speed the reaction, but require removal of excess of unreacted acid or anhydride by, for instance, distillation.

The capped polyether fatty polyesters correspond to Formula 1 above except that the terminal H on the molecular moiety represented by O(CH₂—CHR¹⁻O)ₓH is replaced by R² to form O(CH₂—CHR¹⁻O)ₓR², wherein the structure of R² varies with the capping agent and is the molecular moiety introduced by the capping agent. In the case of methyl chloride or dimethyl sulfate, R² is a methyl group. When the capping agent is a carboxylic acid derivative, R² is the —C(═O)R³ group introduced, wherein R³ is the hydrocarbyl group of from 1 to 18 carbon atoms. When the capping agent is a higher epoxide, R² is —CR⁴R⁵—CR⁶R⁷—OH where R⁴, R⁵, R⁶ and R⁷ are each independently H or a hydrocarbyl group of ≧one carbon atom and preferably two carbon atoms, to ≦10 carbon atoms, preferably ≦6 carbon atoms, wherein the sum of the carbon atoms in R⁴, R⁵, R⁶ and R⁷ is ≧two carbon atoms, preferably ≧four carbon atoms, more preferably ≧six carbon atoms and independently ≦10 carbon atoms, and preferably ≦8 carbon atoms. When epichlorohydrin is the capping agent, R² is 1-oxy-2,3-epoxypropane.

The capped polyether fatty acid esters and capped polyether fatty polyesters (hereinafter collectively referred to as “capped products”) are useful as functional fluids.

The capped product preferably has at least one of friction properties as indicated by a low coefficient of friction of preferably ≦0.07, more preferably ≦0.06, most preferably ≦0.05; pour point at a temperature of ≦0° C., preferably ≦−5° C.; viscosity of preferably ≦200° C., more preferably ≦150° C., most preferably ≦100 cSt at a temperature of 40° C.; or thermal oxidative stability preferably ≦five mg KOH/g, more preferably ≦two mg KOH/g as measured by acid number change. All these properties are measured by standard tests disclosed herein.

Examples that follow illustrate, but do not limit, various embodiments of this invention. Examples of the invention are numbered while comparative samples, which are not examples of the invention, are designated alphabetically.

### EXAMPLES

### Example 1

### Formation of a Polyether Fatty Acid Ester Starting with Methyl 12Hydroxy Stearate

Place a 1490.88 g sample of M12HS (CAS141-23-1), commercially available from Jayant Oils and Derivatives Ltd (Mumbai) in the form of a solid that contains 1500 ppm of water, into a 10 liter (L) stainless steel laboratory reactor having an oil bath, an upper feed valve for introducing gaseous materials, and an upper opening for adding solid and liquid materials. The upper opening can be closed upon addition of the solid and liquid materials and a lower valve for removing samples. Achieve temperature control through heating the oil bath; therefore, temperatures recorded in this example are those of the oil bath rather than the reactor itself. Heat the oil bath to 90° C. When the M12HS begins to melt, start the agitation system at minimum speed, controlled by agitator motor with torque control. After the M12HS is completely melted, add 7 drops of 85 wt % phosphoric acid (H₃PO₄) in water to produce a mixture that has 0.1363 g (77.7 ppm) H₃PO₄. Dry the mixture by stripping at 145° C. oil bath temperature under vacuum and with nitrogen stripping for 2 hours. Cool the oil bath to 90° C., open the reactor under a nitrogen flow to prevent inflow of oxygen, take a 16.4 g sample of the dried mixture using a syringe and silicon tube, then close the reactor. A Karl Fisher analysis of the sample shows that it contains 108 ppm water.

Continuing the nitrogen flow, open the reactor again to introduce 2.0510 g of double metal cyanide (DMC) catalyst (Type P5 commercially available from CAC Shangai under the trade designation P5). Close the reactor and reduce the pressure to vacuum while increasing the oil bath temperature to 145° C. and agitation to 220-230 rpm (revolutions per minute). Add 239.9 g of propylene oxide (PO) at a rate of 50 g/min. After 30 minutes (min), introduce an additional 1059 g of PO into the reactor at a rate of 15.19 g/min (somewhat less than 250 Daltons eqMW/h) resulting in five moles of PO/mole of M12HS.

After completing PO addition and allowing reaction of reactor contents to proceed for 60 minutes, increase reactor pressure to somewhat greater than atmospheric using nitrogen. Take a 259.4 g sample of reactor contents (including product) by opening the bottom valve. Karl Fisher analysis shows that it contains 57 ppm of water. By calculation, the sample contains 804 ppm of catalyst.

After taking the sample, return the reactor to vacuum and set the oil temperature controller to 130° C. Add an additional 1182 g of PO at 16.95 g/min (resulting in a total of about 10 mol of PO/mol of M12HS being added). No antioxidant is added to the reactor.

The reactor contents constitute an oily product that has a viscosity of 35 megapascals·second (mPa·s) at 50° C. as determined by the procedures of International Standards Organization (ISO) 3219 and an OH-value of 92.8 mgKOH/g as determined by the procedures of ASTM D4272-94d, which corresponds to a theoretical molecular weight of 605 Daltons.

### Example 2

### Methyl Capping

Charge a 884.6 g sample of M12HS propoxylated with five moles of propylene oxide using a DMC catalyst by the procedure used in Example 1 to the stainless steel reactor and sparge the sample with nitrogen under reduced pressure (less than (<) five millibars (mbar) (<500 Pa)) at a temperature of 80° C. After 30 minutes, increase the pressure to one atmosphere and add 375.8 grams (g) of a 25 wt % solution of sodium methoxide (NaOMe) in methanol to form a mixture. Sparge the mixture under reduced pressure for a period of four hours to remove methanol. Feed methyl chloride (CH₃Cl) (100 g) into the reactor at a rate of 10 g/min and a temperature of 80-82° C. After a digestion time of eight hours at a stirring speed of 200 rpm, cool the oil bath to 40° C., and wash reactor contents with water (H₂O) (300 milliliters (mL)) and magnesium silicate, commercially available from PQ Europe under the trade designation AMBOSOL™ (40 g) to yield a crude mixture. Extract the crude mixture with hexane (200 mL), filter the crude mixture, and evaporate solvent from the filtered mixture under reduced pressure to yield an oily product. The product has an estimated capping conversion in excess of 90%; based on OH-number determination according to ASTM D4272-94d.

The oily product has a viscosity of 96.7 centistokes (cSt) (98.9 megapascal seconds (mPa s)) at 40° C. and 16.9 cSt (17.3 mPa s) at 100° C. for a viscosity index (VI) of 191 as determined by ISO 3219 and an OH-value of 3.66 mgKOH/g as determined by ASTM D4272-94d. The total acid number as determined by the procedures of ASTM D974 is 1.36 mgKOH/g.

### Example 3

Physically blend 1210 g of the product of Example 1 with 104 g of neopentylglycol (NPG) in a glass flask equipped with the stirrer motor, a thermometer and a nitrogen sparge at 50 ml/min and a Dean Stark distilling trap to collect methanol. Slowly heat the blend to 180° C. over a period of several hours. After three hours, add 200 ppm of tetraisopropyl-ortho-titanate catalyst. Collect a total of 64 grams of methanol over a period of seven hours at 180° C. The resulting liquid is a light brown oil of lubricating viscosity. The oil has a viscosity of 88.8 mPa s at 40° C. and 11.4 mPa s at 100° C. for a VI of 116 and an OH-value of 192 mgKOH/g. The total acid number is 0.08 mgKOH/g.

1. A compound structurally represented by Formula 1: 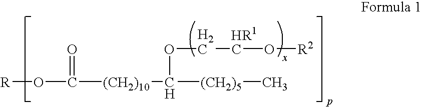
wherein x is an integer within a range of from 1 to 30; p is an integer within a range of from 2 to 8; R is any alkyl, alkenyl, alicyclic or heterocyclic moiety of at least any of 5 to 12 carbon atoms; R¹ is the hydrogen or —CH₃; R² is H or a methyl group, —C(═O)R³ (wherein R³ is a hydrocarbyl group of from 1 carbon atom to 18 carbon atoms), —CR⁴R⁵—CR⁶R⁷—OH where R⁴, R⁵, R⁶ and R⁷ are each independently H or a hydrocarbyl group of at least 1 carbon atom to at most 10 carbon atoms, wherein the sum of the carbon atoms in R⁴, R⁵, R⁶ and R⁷ is at least 2 carbon atoms and at most 10 carbon atoms.

2. The compound of claim 1, wherein the compound is a polyether fatty acid or a derivative thereof.

3. The compound claim 1, wherein the compound is a capped polyether fatty acid or derivative thereof.

4. A process for preparing a polyether of a saturated monobasic secondary hydroxy fatty acid comprising a step of (1) contacting at least one saturated monobasic secondary hydroxy fatty acid or derivative thereof with at least one alkoxide in the presence of at least one double metal cyanide catalyst such that at least one polyether of the fatty acid is formed.

5. The process of claim 4 additionally comprising at least one step of (2) capping the resulting polyether, or of (3) contacting at least one resulting polyether with at least one polyhydric alcohol or (4) a combination of both (2) and (3).

6. The process of claim 4 wherein the alkoxides is propylene oxide, the propylene oxide and the saturated monobasic secondary hydroxy fatty acid being present in a molar ratio of the latter to the former within a range of from 1:30 to 1:1.

7. The process of claim 4, wherein the saturated monobasic hydroxy fatty acid or derivative thereof is 12-hydroxy stearic acid, its anhydride, chloride, or its ester with an alcohol of from 1 carbon atom to 6 carbon atoms.

8. The process of claim 7 wherein the alcohol is a polyhydric alcohol that has an average of at least 2 hydroxyl groups and at most 8 hydroxyl groups and has an average equivalent weight of at least 24 Daltons and at most 100 Daltons.

9. The process of claim 8, wherein the polyhydric alcohol is selected from trimethylolpropane (TMP), pentaerythritol (PE), dipentaerythritol (DPE), neopentyl glycol (NPG), 2-methyl-2-propyl-1,3-propanediol (MPPD) and combinations thereof.

10. The process of claim 5, wherein capping occurs via a capping agent selected from a short chain (C₂-C₁₈) carboxylic acid, a short chain (C₂-C₁₈) carboxylic acid anhydride, a short chain (C₂-C₁₈) carboxylic acid chloride, a short chain (C₂-C₁₈) carboxylic acid ester; a hindered epoxide having from 4 carbon atoms to 8 carbon atoms; epichlorohydrin; methyl chloride; dimethyl sulfate; sodium methoxide; or a combination thereof.

11. The process of claim 10, wherein the capping agent is a methyl or ethyl ester of a carboxylic acid having from 6 carbon atoms to 12 carbon atoms.

12. The compound of claim 1, wherein the compound is at least one of a functional fluid plasticizer, lubricant, power transmission fluid, surfactant, solvent, thickening agent, plasticizer, metal working fluid, heat transfer fluid, or monomer for use in or used in making a polymer.

13. The compound of claim 12, wherein the compound is a monomer and the polymer is at least one of a polyurethane, a polyester, a thermoplastic resin, a thermoset epoxy polymer or a combination thereof.

14. The compound of claim 1, wherein the compound has at least one of (a) a coefficient of friction determined using Stribeck curves as established on a PCS MTM Minitraction machine of less than 0.07; (b) a pour point of less than 0° C., as measured by the procedure of ASTM D97; (c) a viscosity as measured by the procedure of ASTM D445-94 of at most any of 200 cSt at 40° C.; (d) an acidity increase measured by the procedure of DIN 51 587 of at most 5 mg KOH/g.
